(19) United States
(12) Patent Application Publication
(10) Pub. No.: US 2014/0127472 A1
(43) Pub. Date: May 8, 2014

(54) CARBON NANOWALL ARRAY AND METHOD FOR MANUFACTURING CARBON NANOWALL

(71) Applicants: Toshio Kawahara, Aichi (JP); Kazumasa Okamoto, Hokkaido (JP); Kazuhiko Matsumoto, Osaka (JP); Risa Utsunomiya, Kyoto (JP); Teruaki Matsuba, Kyoto (JP); Hitoshi Matsumoto, Kyoto (JP)

(72) Inventors: Toshio Kawahara, Aichi (JP); Kazumasa Okamoto, Hokkaido (JP); Kazuhiko Matsumoto, Osaka (JP); Risa Utsunomiya, Kyoto (JP); Teruaki Matsuba, Kyoto (JP); Hitoshi Matsumoto, Kyoto (JP)

(73) Assignees: CHUBU UNIVERSITY EDUCATIONAL FOUNDATION, AICHI (JP); NISSIN ELECTRIC CO., LTD., KYOTO (JP); OSAKA UNIVERSITY, OSAKA (JP); NATIONAL UNIVERSITY CORPORATION HOKKAIDO UNIVERSITY, HOKKAIDO (JP)

(21) Appl. No.: 14/130,321

(22) PCT Filed: Jun. 26, 2012
(86) PCT No.: PCT/JP2012/066295

§ 371 Date: Dec. 31, 2013

(30) Foreign Application Priority Data
Jul. 5, 2011 (JP) 2011-149002

(51) Int. Cl. C01B 31/02

(52) U.S. Cl. CPC C01B 31/0293
USPC 428/172; 427/577

(57) ABSTRACT

A carbon nanowall array (10) is provided with a substrate (1) and carbon nanowalls (2-9). The substrate (1) is composed of silicon, and includes protruding portions (11) and recessed portions (12). The protruding portions (11) and recessed portions (12) are formed in the direction (DR1) on one surface of the substrate (1). The protruding portions (11) and recessed portions (12) are alternately formed in the direction (DR2) perpendicular to the direction (DR1). Each of the protruding portions (11) has a length of 0.1-0.5 μm in the direction (DR2), and each of the recessed portions (12) has a length of 0.6-1.5 μm in the direction (DR2). The height of each of the protruding portions (11) is 0.3-0.6 μm. Respective carbon nanowalls (2-9) are formed in the length direction (i.e., the direction (DR1)) of the protruding portions (11) of the substrate (1), said carbon nanowalls being formed on the protruding portions (11).

### BACKGROUND OF THE INVENTION

1. Field of the Invention

The invention relates to a carbon nanowall array and a method for manufacturing carbon nanowalls.

2. Description of Related Art

A manufacturing method of carbon nanowalls has been proposed in the prior art (Patent Literature 1). This manufacturing method is to manufacture carbon nanowalls using a plasma apparatus.

The plasma apparatus includes a parallel plate-type capacitively coupled plasma generation mechanism and a radical generation means. The parallel plate-type capacitively coupled plasma generation mechanism applies a RF electric power, which is 5 W-2 kW or so and has a frequency of 13.56 MHz, to a first electrode and a second electrode that are disposed parallel in a reaction chamber, and generates a RF wave, etc., in the reaction chamber.

The radical generation means generates a radical of hydrogen atoms, etc., by inductively coupled plasma in a radical generation chamber that is connected to the reaction chamber through a radical inlet. The generated radical is introduced into the reaction chamber via the radical inlet.

A substrate composed of silicon is disposed on the second electrode. A methane gas is introduced into the reaction chamber, and when the pressure in the reaction chamber reaches 10-1000 mTorr, the parallel plate-type capacitively coupled plasma generation mechanism applies the RF electric power to the first and the second electrodes, thereby generating plasma in the reaction chamber.

Moreover, the radical generation means generates a radical in the radical generation chamber by inductively coupled plasma. Then, the generated radical is introduced into the reaction chamber via the radical inlet.

Accordingly, carbon nanowalls are formed on the substrate.

According to Patent Literature 1, aligned carbon nanowalls are obtained by disposing the substrate on the second electrode with a substrate surface perpendicular to a flow direction of the radical supplied from the radical generation chamber.
Patent Literature 1: Japanese Patent Publication No. 2006-69816

### SUMMARY OF THE INVENTION

However, when using the conventional manufacturing method to manufacture carbon nanowalls, there is a problem that the carbon nanowalls cannot be aligned in a desired pattern.

The invention is provided to address the problem. A purpose of the invention is to provide a carbon nanowall array with carbon nanowalls that can be aligned in the desired pattern.

In addition, another purpose of the invention is to provide a manufacturing method for manufacturing carbon nanowalls that can be aligned in the desired pattern.

According to an exemplary embodiment of the invention, the carbon nanowall array includes a substrate and a plurality of carbon nanowalls. The substrate has a main surface, on which a stripe-like or grid-like concave-convex shape is formed. The plurality of carbon nanowalls are formed on protruding portions of the concave-convex shape along a length direction of the protruding portions. A width of each of the protruding portions in an in-plane direction of the substrate is narrower than a width of each of recessed portions of the concave-convex shape in the in-plane direction of the substrate, and the width of each of the protruding portions is 0.5 μm or less.

Moreover, according to an exemplary embodiment of the invention, the method for manufacturing carbon nanowalls is a method that uses plasma to manufacture carbon nanowalls, and includes a first process of disposing a substrate, which has a main surface formed with a stripe-like or grid-like concave-convex configuration, in a vacuum container; a second process of heating a temperature of the substrate to a desired temperature; a third process of introducing a material gas containing carbon atoms into the vacuum container; and a fourth process of applying a high-frequency electric power to an electrode, wherein a width of a protruding portion of the concave-convex configuration in an in-plane direction of the substrate is narrower than a width of a recessed portion of the concave-convex configuration in the in-plane direction of the substrate, and the width of the protruding portion is 0.5 μm or less.

In a carbon nanowall array of an exemplary embodiment of the invention, a concave-convex shape is formed on a main surface of a substrate. The concave-convex configuration has a shape that a width of a protruding portion in an in-plane direction of the substrate is narrower than a width of a recessed portion of the concave-convex shape in the in-plane direction of the substrate, and the width of the protruding portion is 0.5 μm or less. As a result, a plurality of carbon nanowalls is formed on the protruding portions along a length direction of the protruding portions of the concave-convex configuration.

Thus, the carbon nanowalls can be aligned in the desired pattern.

Moreover, a method for manufacturing carbon nanowalls according to an exemplary embodiment of the invention is to use plasma to manufacture a plurality of carbon nanowalls having a concave-convex configuration on a substrate. The concave-convex configuration of the substrate has a width of a protruding portion in an in-plane direction of the substrate being narrower than a width of a recessed portion of the concave-convex configuration in the in-plane direction of the substrate, and the width of the protruding portion is 0.5 μm or less. As a result, when using plasma to form carbon nanowalls on the substrate, the plurality of carbon nanowalls are grown along a length direction of the protruding portion of the substrate.

Thus, the carbon nanowalls can be aligned in the desired pattern.

### BRIEF DESCRIPTION OF THE DRAWINGS

FIG. 1 is a schematic perspective view of a carbon nanowall array according to an exemplary embodiment of the invention.

FIG. 2 is a schematic cross-sectional view showing a structure of a plasma apparatus for manufacturing the carbon nanowall array of FIG. 1.

FIG. 3 is a plan view of a plane conductor, a power feeding electrode, and a termination electrode when viewed from the side of a matching circuit of FIG. 2.

FIG. 4 includes a schematic cross-sectional view of the plane conductor in a Y direction and a diagram showing a plasma density.

FIG. 5 is a flowchart showing a manufacturing method of the carbon nanowall array of FIG. 1.

FIG. 6 provides SEM photographs of carbon nanowalls of Pattern No. 3-6.

FIG. 7 provides SEM photographs of carbon nanowalls of Pattern No. 7-10.

FIG. 8 provides SEM photographs of carbon nanowalls of Pattern No. 11.

FIG. 9 provides enlarged SEM photographs of Pattern No. 8 and 9.

FIG. 10 provides schematic views showing an aperture ratio and a protrusion ratio of a surface of a substrate.

FIG. 11 is a schematic perspective view of a mold using carbon nanowalls.

### DESCRIPTION OF THE EMBODIMENTS

Exemplary embodiments of the invention are described in detail below with reference to the drawings. It should be noted that, in the drawings, identical or equivalent parts are assigned with the same reference numerals and descriptions thereof will not be repeated.

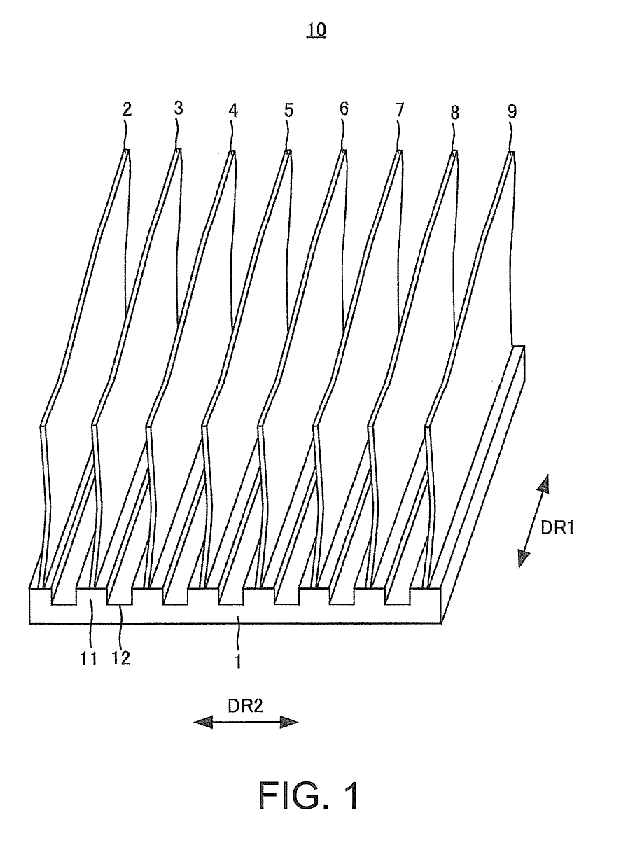

FIG. 1 is a schematic perspective view of a carbon nanowall array according to an exemplary embodiment of the invention. With reference to FIG. 1, a carbon nanowall array 10 of an exemplary embodiment of the invention includes a substrate 1 and a plurality of carbon nanowalls 2-9.

The substrate 1 is formed of silicon or glass, for example. The substrate 1 includes protruding portions 11 and recessed portions 12. The protruding portions 11 and the recessed portions 12 are formed in a direction DR1 on a surface of the substrate 1. A length of each of the protruding portions 11 and a length of each of the recessed portions 12 may be respectively equal to or smaller than a length of the substrate 1 in the direction DR1. The protruding portions 11 and the recessed portions 12 are alternately formed in a direction DR2, which is perpendicular to the direction DR1. Each of the protruding portions 11 has a length of 0.1-0.5 μm in the direction DR2. Each of the recessed portions 12 has a length of 0.6-1.5 μm in the direction DR2. That is, each of the protruding portions 11 has a width of 0.1-0.5 μm, and each of the recessed portions 12 has a width of 0.6-1.5 μm. In addition, a height of each of the protruding portions 11 (which is equal to a depth of each of the recessed portions 12) is 0.3-0.6 μm.

In this way, one surface of the substrate 1 has a stripe-like concave-convex configuration formed thereon.

Each of the carbon nanowalls 2-9 is formed on the protruding portions 11 in a length direction (i.e. the direction DR1) of the protruding portions 11 of the substrate 1.

In addition, each of the carbon nanowalls 2-9 has a thickness of 10-15 nm and a height of 60-2500 nm.

In this way, the plurality of carbon nanowalls 2-9 is arranged in the length direction of the protruding portions 11 of the substrate 1. In other words, the plurality of carbon nanowalls 2-9 is aligned in a desired pattern.

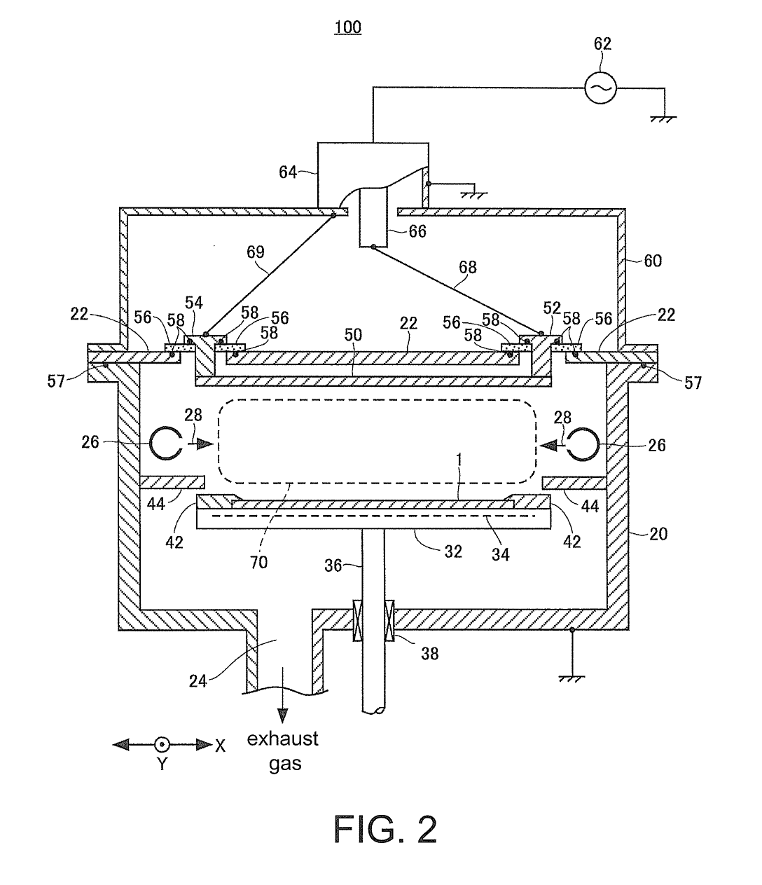

FIG. 2 is a schematic cross-sectional view showing a structure of a plasma apparatus for manufacturing the carbon nanowall array 10 of FIG. 1. With reference to FIG. 2, a plasma apparatus 100 includes a vacuum container 20, a top plate 22, an exhaust port 24, a gas inlet 26, a holder 32, a heater 34, a shaft 36, a bearing portion 38, a mask 42, a partition plate 44, a plane conductor 50, a power feeding electrode 52, a termination electrode 54, an insulating flange 56, packings 57 and 58, a shield box 60, a high-frequency power source 62, a matching circuit 64, and connection conductors 68 and 69.

The vacuum container 20 is made of a metal and is connected with a vacuum exhaust device via the exhaust port 24. Furthermore, the vacuum container 20 is electrically connected with a ground node. The top plate 22 is disposed to be in contact with the vacuum container 20 so as to close an upper side of the vacuum container 20. In this case, the packing 57 for vacuum sealing is disposed between the vacuum container 20 and the top plate 22.

The gas inlet 26 is disposed above the partition plate 44 in the vacuum container 20. The shaft 36 is fixed to a bottom surface of the vacuum container 20 via the bearing portion 38. The holder 32 is secured to an end of the shaft 36. The heater 34 is disposed in the holder 32. The mask 42 is disposed on the holder 32 and located at a peripheral edge portion of the holder 32. The partition plate 44 is fixed to a side wall of the vacuum container 20 and located above the holder 32 for closure between the vacuum container 20 and the holder 32.

The power feeding electrode 52 and the termination electrode 54 are fixed to the top plate 22 via the insulating flange 56. In this case, the packing 58 for vacuum sealing is disposed between the top plate 22 and the insulating flange 56.

The plane conductor 50 is disposed so that two end portions thereof in an X direction are respectively in contact with the power feeding electrode 52 and the termination electrode 54.

A length of the power feeding electrode 52 and a length of the termination electrode 54 are substantially equal to a length of the plane conductor 50 respectively in a Y direction (i.e. a direction perpendicular to the paper plane of FIG. 2), as described later. In addition, the power feeding electrode 52 is connected with an output bar 66 of the matching circuit 64 by the connection conductor 68. The termination electrode 54 is connected with the shield box 60 via the connection conductor 69. The plane conductor 50, the power feeding electrode 52, and the termination electrode 54 are formed of copper and aluminum, etc., for example.

The shield box 60 is disposed on the upper side of the vacuum container 20 and is in contact with the top plate 22. The high-frequency power source 62 is connected between the matching circuit 64 and the ground node. The matching circuit 64 is disposed on the shield box 60.

The connection conductors 68 and 69 are plate-shaped and each have a length substantially equal to the lengths of the power feeding electrode 52 and the termination electrode 54 in the Y direction.

The gas inlet 26 supplies a gas 28, such as methane (CH₄) gas and hydrogen (H₂) gas, etc., supplied from a gas cylinder (not shown), into the vacuum container 20. The holder 32 supports the substrate 1. The heater 34 heats the substrate 1 to a desired temperature. The shaft 36 supports the holder 32. The mask 42 covers a peripheral edge portion of the substrate 1, so as to prevent a product from being formed at the peripheral edge portion of the substrate 1. The partition plate 44 prevents plasma 70 from reaching a holding mechanism of the substrate 1.

The power feeding electrode 52 supplies a high-frequency current that is supplied from the connection conductor 68 to the plane conductor 50. The termination electrode 54 connects an end portion of the plane conductor 50 to the ground node directly or via a capacitor so as to form a close loop of the high-frequency current between the high-frequency power source 62 and the plane conductor 50.

The high-frequency power source 62 supplies a high-frequency electric power of 13.56 MHz, for example, to the matching circuit 64. The matching circuit 64 suppresses reflection of the high-frequency electric power supplied from the high-frequency power source 62 and supplies the same to the connection conductor 68.

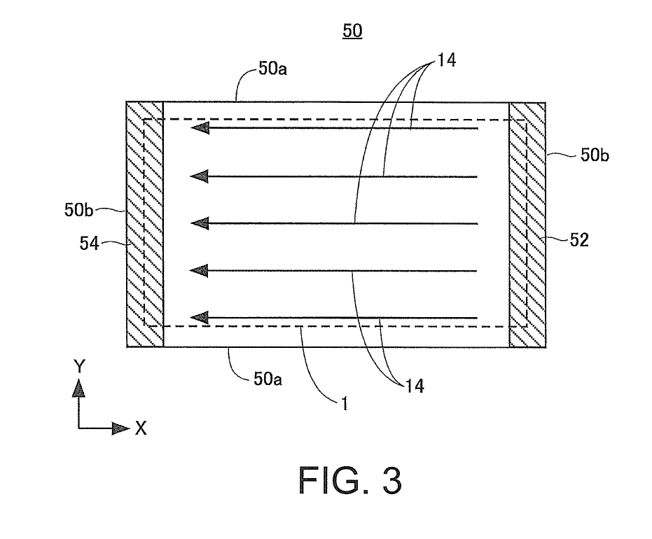

FIG. 3 is a plan view of the plane conductor 50, the power feeding electrode 52, and the termination electrode 54 when viewed from the side of the matching circuit 64 of FIG. 2. With reference to FIG. 3, the plane conductor 50 has a rectangular plane shape, for example, and has sides 50a and 50b. The side 50a is longer than the side 50b. Moreover, the side 50a is arranged in the X direction while the side 50b is arranged in the Y direction.

The power feeding electrode 52 and the termination electrode 54 are respectively disposed at the two end portions of the plane conductor 50 in the X direction and arranged along the sides 50b of the plane conductor 50. In order to make the high-frequency current 14 flow as uniform as possible in the Y direction, preferably the lengths of the power feeding electrode 52 and the termination electrode 54 in the Y direction approximate to the lengths of the sides 50b, parallel to the Y direction, of the plane conductor 50 (for instance, the lengths of the sides 50b are substantially equal). However, the lengths of the power feeding electrode 52 and the termination electrode 54 in the Y direction may be somewhat longer or shorter than the lengths of the sides 50b. When represented in figures, the lengths of the power feeding electrode 52 and the termination electrode 54 in the Y direction may be set to be 85% of the lengths of the sides 50b or more.

The power feeding electrode 52 and the termination electrode 54 are block-shaped electrodes. Thus, the high-frequency current 14 can flow in the plane conductor 50 substantially uniformly in the Y direction.

When using point-shaped electrodes to supply the high-frequency current to the plane conductor 50, the high-frequency current does not flow uniformly through the plane conductor 50. Generally, even when high-frequency electric power is supplied to the plane conductor, in a state where plasma is not present in the vicinity of the plane conductor, the high-frequency current flows with concentration at four corners of a cross-section that is orthogonal to a conducting direction of the plane conductor due to a skin effect, etc. The reason is that a distribution of high-frequency impedance becomes smaller at the four corners of the plane conductor and becomes larger at other portions.

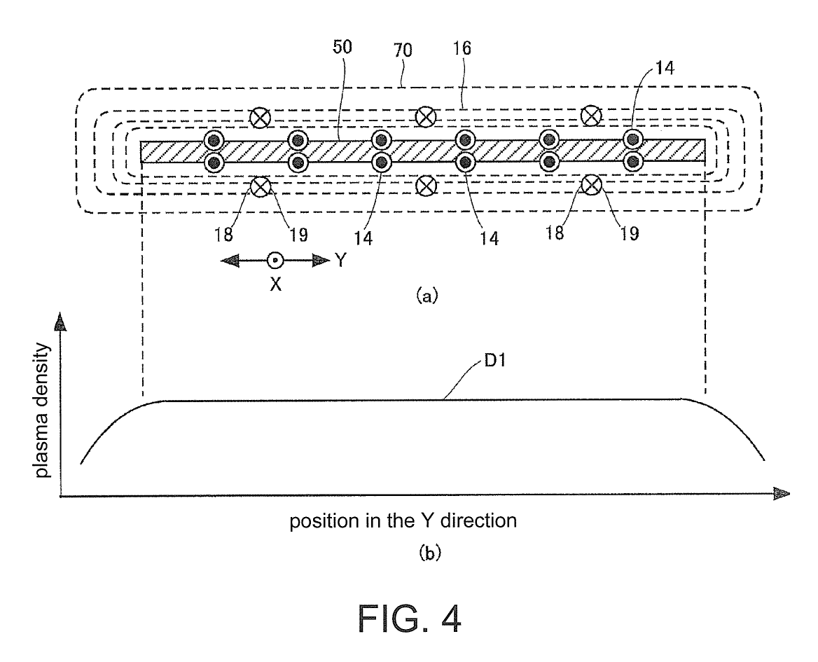

FIG. 4 includes a schematic cross-sectional view of the plane conductor 50 in the Y direction and a diagram showing a plasma density. In the plasma apparatus 100, the plasma 70 is generated in the vicinity of the plane conductor 50. That is, as shown in FIG. 4, when the high-frequency current 14 flows in the plane conductor 50, a high-frequency magnetic field 16 is generated around the plane conductor 50, and thereby an induced electric field 18 is generated in an opposite direction of the high-frequency current 14. Then, electrons are accelerated by the induced electric field 18 and the gas 28 in the vicinity of the plane conductor 50 (see FIG. 2) is ionized. The plasma 70 is generated in the vicinity of the plane conductor 50, and an induced current 19 flows in the plasma 70 in the same direction (i.e. the opposite direction of the high-frequency current 14) as the induced electric field 18.

Accordingly, when the plasma 70 is generated in the vicinity of the plane conductor 50 and the induced current 19 flows in the plasma 70 in the opposite direction of the high-frequency current 14, the high-frequency current 14 that flows through the plane conductor 50 becomes uniform in the Y direction that is orthogonal to the conducting direction. The reason is explained below.

In the technical field of electric power distribution, it is known that, if a current flowing in a plane conductor such as a bus bar, is in an opposite direction to a current flowing in another conductor nearby, impedance distributions of the conductors change each other, and low impedances and uniformization of impedances occur. It is considered to be related with the decrease of the number of interlinkages of magnetic flux resulting from the flow of currents in opposite directions. The plasma apparatus 100 applies such a phenomenon to the relationship between the plane conductor and the plasma.

Thus, as shown in FIG. 4, when plasma, especially the high-density plasma 70, is generated in the vicinity of the plane conductor 50, the distribution of the high-frequency current 14 that flows in the plane conductor 50 is uniformized in the Y direction. By combining the aforementioned with disposition of the block-shaped power feeding electrode 52 and termination electrode 54, the high-frequency current 14 flows in the plane conductor 50 with a substantially uniform distribution in the Y direction. Therefore, the induced electric field 18 and the induced current 19, which are distributed substantially uniformly not only in the X direction (i.e. the conducting direction) but also in the Y direction orthogonal to the X direction, are generated near a face of the plane conductor 50, at which the plasma 70 is generated. Due to the induced electric field 18, the plasma can be generated with good uniformity over a wide range along the face of the plane conductor 50. A plasma density distribution D1 is substantially uniform as shown in FIG. 4.

Accordingly, the plasma apparatus 100 generates inductively coupled plasma by uniform flow of the high-frequency current 14 in the plane conductor 50.

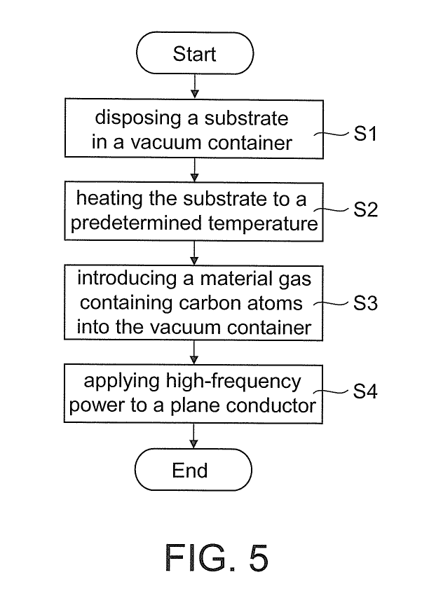

FIG. 5 is a flowchart showing a manufacturing method of the carbon nanowall array 10 of FIG. 1. With reference to FIG. 5, when the manufacture of the carbon nanowall array 10 begins, for example, a silicon wafer having a size of 1 cm×1 cm is patterned using electron beam lithography, and a surface of the silicon wafer is etched by reactive ion etching to form the protruding portions 11 and the recessed portions 12 thereon. Then, the silicon wafer formed with the protruding portions 11 and the recessed portions 12 is used as the substrate 1 and disposed on the holder 32 in the vacuum container 20 (Step S1).

Next, the heater 34 is used to heat the substrate 1 to a temperature of 400-600° C. (Step S2). Following that, the gas inlet 26 supplies CH₄ gas of 50 sccm and H₂ gas of 50 sccm, or CH₄ gas of 100 sccm, to the vacuum container 20, that is, to introduce a material gas containing carbon atoms into the vacuum container 20 (Step S3). Then, a pressure in the vacuum container 20 is adjusted to 1.33 Pa.

Thereafter, the high-frequency power source 62 applies high-frequency electric power of 1 kW, which has a frequency of 13.56 MHz, to the plane conductor 50 via the matching circuit 64 and the connection conductor 68 (Step S4).

Accordingly, the plasma 70 is generated in the vacuum container 20 and the carbon nanowalls 2-9 are formed by self-organization on the protruding portions 11 of the substrate 1. In this case, the formation time of the carbon nanowalls 2-9 is about 10-30 minutes.

When 10-30 minutes have passed since the start of application of the high-frequency electric power, application of the high-frequency electric power is stopped and supply of the CH₄ gas and H₂ gas (or the CH₄ gas) is stopped. Thereby, the manufacture of the carbon nanowall array 10 is completed.

In this way, the carbon nanowall array 10 is manufactured using inductively coupled plasma.

Results regarding alignment of the carbon nanowalls obtained by varying the widths of the protruding portions 11 and the recessed portions 12 of the substrate 1, the substrate temperature, and the reaction time are described below.

The experiment results obtained when the widths of the protruding portions 11 and the recessed portions 12, the substrate temperature, and the reaction time are varied are shown in Table 1. In this case, a total flow of the CH₄ gas and H₂ gas, a reaction pressure, and the high-frequency electric power are constant, wherein a flow of the CH₄ gas is 50 sccm, a flow of the H₂ gas is 50 sccm, the reaction pressure is 1.33 Pa, and the high-frequency electric power is 1 kW. Further, the height of the protruding portion 11 (which is equal to the depth of the recessed portion 12) of the substrate 1 is also constant, that is, 0.6 μm.

TABLE 1

| | Width (μm) | Width (μm) | Substrate | Reaction | |
|---|---|---|---|---|---|
| Pattern | of recessed | of protruding | temperature | time | Align- |
| No. | portion | portion | (° C.) | (minute) | ment |
| 1 | 0.3-0.4 | 0.4 | 600 | 30 | Random |
| 2 | 0.4 | 0.5-0.6 | 600 | 30 | Random |
| 3 | 0.7-0.8 | 1.2 | 600 | 30 | Random |
| 4 | 4.8-4.9 | 4.7-4.8 | 600 | 30 | Random |
| 5 | 0.6 | 0.3-0.4 | 600 | 30 | Aligned |
| 6 | 0.9 | 0.1 | 600 | 30 | Aligned |
| 7 | 1.5 | 0.4-0.5 | 600 | 30 | Aligned |
| 8 | 1.5 | 0.4-0.5 | 500 | 30 | Aligned |
| 9 | 1.5 | 0.4-0.5 | 400 | 30 | Aligned |
| 10 | 1.5 | 0.4-0.5 | 500 | 10 | Aligned |
| 11 | 5.1-5.2 | 4.3-4.4 | 600 | 30 | Random |

In the cases of Pattern No. 9 and 10, CH₄ gas of 100 sccm is solely used as the material gas.

As shown in Table 1, the substrate temperature is varied in a range of 400-600° C. and the reaction time is varied in a range of 10-30 minutes.

With respect to Pattern No. 1-4 and 11, the carbon nanowalls are formed random on the substrate 1.

With respect to Pattern No. 5-10, the carbon nanowalls are aligned on the substrate 1.

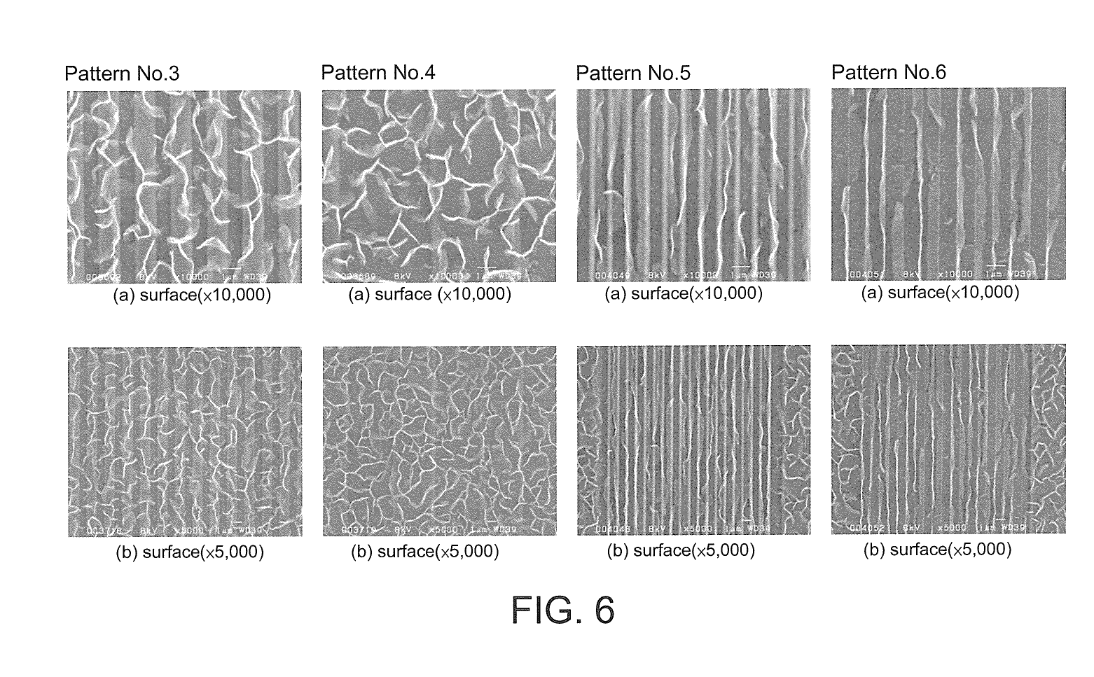

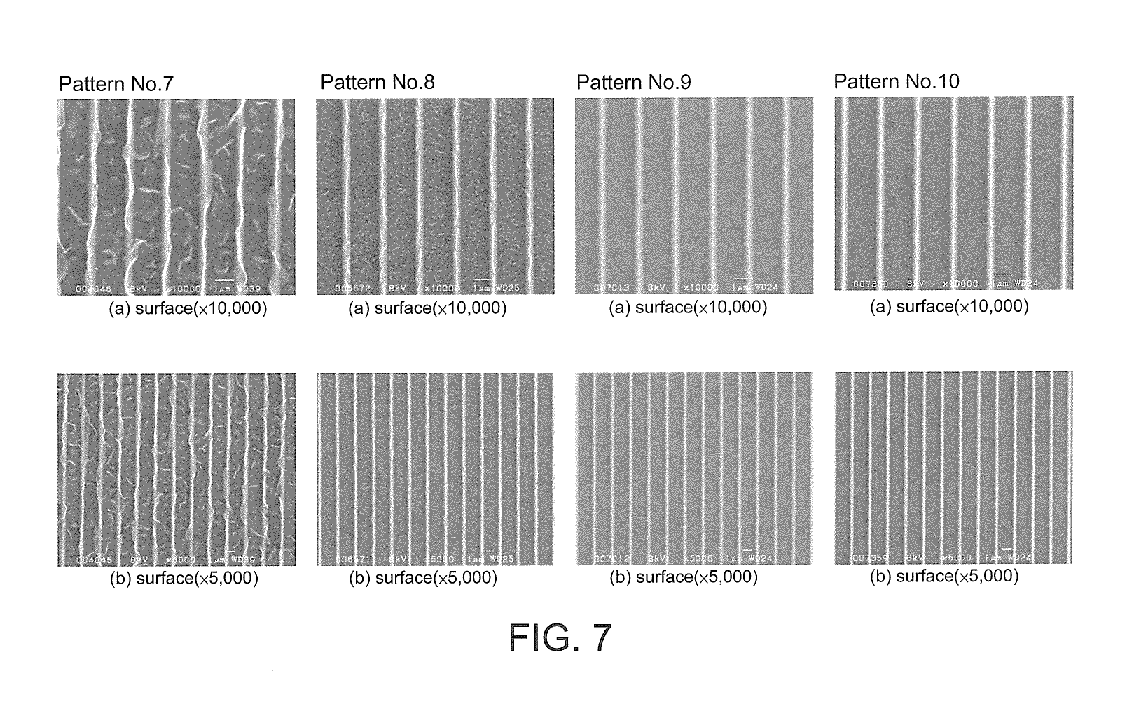

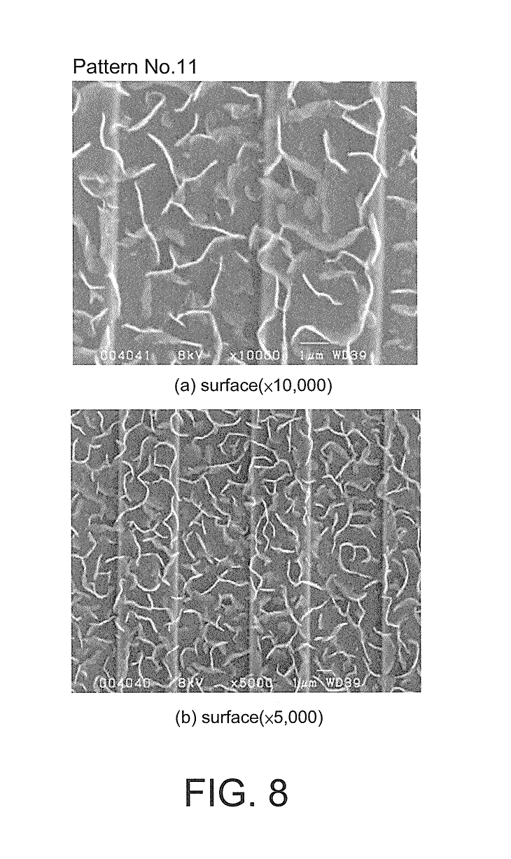

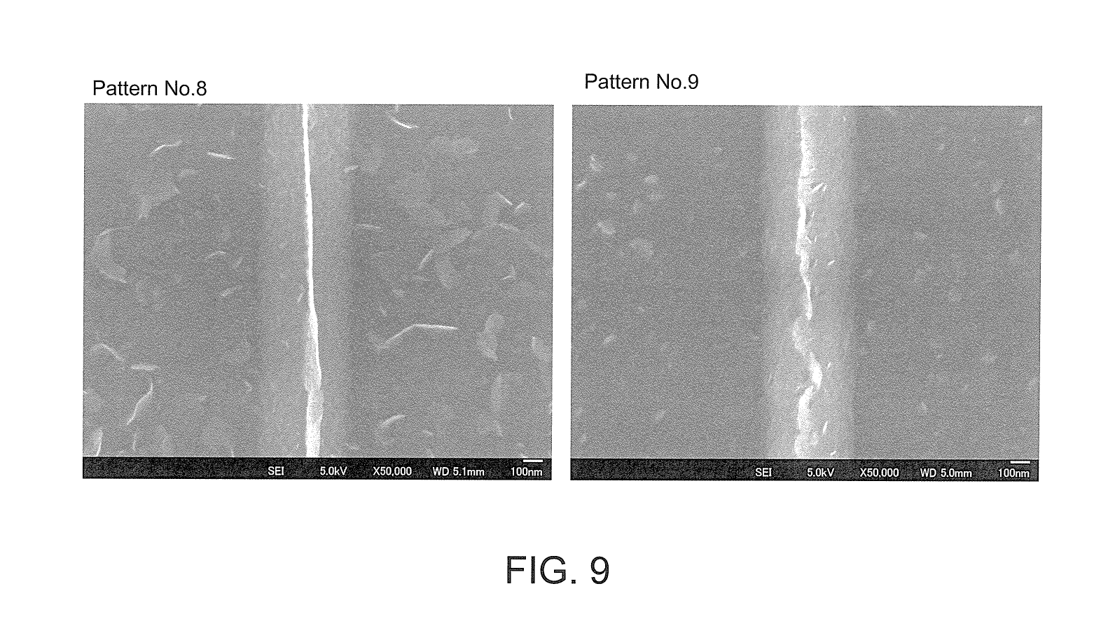

FIG. 6 provides SEM photographs of carbon nanowalls of Pattern No. 3-6. FIG. 7 provides SEM photographs of carbon nanowalls of Pattern No. 7-10. FIG. 8 provides SEM photographs of carbon nanowalls of Pattern No. 11. FIG. 9 provides enlarged SEM photographs of Pattern No. 8 and 9.

Provided in the upper rows of FIG. 6 to FIG. 8 are SEM photographs magnified 10,000 times, and SEM photographs magnified 5,000 times are in the lower rows. Furthermore, the SEM photographs of the carbon nanowalls, shown in FIG. 6 to FIG. 8, are taken in a direction perpendicular to the substrate 1.

With reference to FIG. 6, in the case that the width of the protruding portion 11 of the substrate 1 is 1.2 μm, the width of the recessed portion 12 is 0.7-0.8 μm, the substrate temperature is 600° C., and the reaction time is 30 minutes, the carbon nanowalls are formed random on the substrate 1 (referring to Pattern No. 3).

Additionally, in the case that the width of the protruding portion 11 of the substrate 1 is 4.7-4.8 μm, the width of the recessed portion 12 is 4.8-4.9 μm, the substrate temperature is 600° C., and the reaction time is 30 minutes, the carbon nanowalls are formed random on the substrate 1 (referring to Pattern No. 4).

However, in the case that the width of the protruding portion 11 of the substrate 1 is 0.3-0.4 μm, the width of the recessed portion 12 is 0.6 μm, the substrate temperature is 600° C., and the reaction time is 30 minutes, the carbon nanowalls are aligned on the substrate 1 (referring to Pattern No. 5). In the SEM photographs, a white portion having a constant width represents the protruding portion 11 of the substrate 1, and thus it is understood that the carbon nanowalls are not formed in the recessed portions 12 of the substrate 1 but formed along the protruding portions 11.

Also, in the case that the width of the protruding portion 11 of the substrate 1 is 0.1 μm, the width of the recessed portion 12 is 0.9 μm, the substrate temperature is 600° C., and the reaction time is 30 minutes, the carbon nanowalls are not formed in the recessed portions 12 of the substrate 1 but formed along the protruding portions 11 (referring to Pattern No. 6).

With reference to FIG. 7, in the case that the width of the protruding portion 11 of the substrate 1 is 0.4-0.5 nm, the width of the recessed portion 12 is 1.5 nm, the substrate temperature is 600° C., and the reaction time is 30 minutes, some of the carbon nanowalls are formed in the recessed portions 12 of the substrate 1 while most are formed along the protruding portions 11 (referring to Pattern No. 7).

Moreover, in the case that the width of the protruding portion 11 of the substrate 1 is 0.4-0.5 μm, the width of the recessed portion 12 is 1.5 μm, the substrate temperature is 500° C., and the reaction time is 30 minutes, the carbon nanowalls are not formed in the recessed portions 12 of the substrate 1 but formed along the protruding portions 11 (referring to Pattern No. 8). As shown by Pattern No. 8 of FIG. 9, a white portion with a narrow width exists in an approximate center of a strip-shaped region having a constant width. The strip-shaped region having the constant width is considered as the protruding portion 11, and the white portion that is narrow in width is considered as the carbon nanowall.

Further, in the case that the width of the protruding portion 11 of the substrate 1 is 0.4-0.5 nm, the width of the recessed portion 12 is 1.5 nm, the substrate temperature is 400° C., and the reaction time is 30 minutes, the carbon nanowalls are not formed in the recessed portions 12 of the substrate 1 but formed along the protruding portions 11 (referring to Pattern No. 9). In this case, as shown by Pattern No. 9 of FIG. 9, a white portion that is narrow in width exists in an approximate center of a strip-shaped region having a constant width. This strip-shaped region having the constant width is considered as the protruding portion 11, and the white portion that is narrow in width is considered as the carbon nanowall.

Additionally, in the case that the width of the protruding portion 11 of the substrate 1 is 0.4-0.5 μm, the width of the recessed portion 12 is 1.5 μm, the substrate temperature is 500° C., and the reaction time is 10 minutes, the carbon nanowalls are not formed in the recessed portions 12 of the substrate 1 but formed along the protruding portions 11 (referring to Pattern No. 10). The SEM photographs of Pattern No. 10 are the same as the SEM photographs of Pattern No. 8 and 9. Therefore, even in Pattern No. 10 as shown in FIG. 9, the carbon nanowalls are considered to be formed on the protruding portions 11.

With reference to FIG. 8, in the case that the width of the protruding portion 11 of the substrate 1 is 4.3-4.4 μm, the width of the recessed portion 12 is 5.1-5.2 μm, the substrate temperature is 600° C., and the reaction time is 30 minutes, the carbon nanowalls are formed random on the substrate 1.

Thus, in the cases of Pattern No. 5-10, the carbon nanowalls are aligned along the concave-convex configuration of the substrate 1, and the alignment of the carbon nanowalls is improved from Pattern No. 5 toward Pattern No. 10.

The carbon nanowalls of Pattern No. 7-9 are respectively formed by using substrate temperatures of 600° C., 500° C., and 400° C. Thus, in the range of substrate temperature from 400° C. to 600° C., the alignment of carbon nanowalls formed with lower substrate temperature can be improved. Aligned carbon nanowalls can be obtained even at the substrate temperature of 400° C. At the substrate temperature of 400° C., it is possible to use low-melting-point substrates and low-melting-point insulating materials. Therefore, using the carbon walls to manufacture devices can increase the flexibility in selection of materials.

Since the carbon nanowalls of Pattern No. 5-10 are aligned, the width of the protruding portion 11 of the substrate 1 is preferably 0.1-0.5 μm, and the width of the recessed portion 12 is preferably 0.6-1.5 μm.

In the cases of Pattern No. 5-10, as described above, the carbon nanowalls are selectively formed on the protruding portions 11 of the substrate 1. It indicates that the growth species produced when the CH₄ gas is decomposed by the inductively coupled plasma is easily attached to the protruding portions 11 of the substrate 1.

By doing so, the carbon nanowalls are considered to be selectively grown on the protruding portions 11 even if the protruding portions 11 have a triangular cross-section with a width of substantially zero.

Therefore, the width of the protruding portion 11 may be 0.5 μm or less. As a result, in the concave-convex configuration of the substrate 1 with the carbon nanowalls aligned thereon, the width of the protruding portion 11 may be narrower than the width of the recessed portion 12, and the width of the protruding portion 11 may be 0.5 μm or less.

In the case of Pattern No. 1, the width of the protruding portion 11 is 0.5 μm or less but wider than the width of the recessed portion 12. Therefore, the carbon nanowalls are randomly formed on the substrate 1.

Moreover, in the case of Pattern No. 2, the situation that the width of the protruding portion 11 is 0.5 μm or less is also included, but the width of the protruding portion 11 is wider than the width of the recessed portion 12. Therefore, the carbon nanowalls are randomly formed on the substrate 1.

Further, in the cases of Pattern No. 3, 4, and 11, the width of the protruding portion 11 is greater than 0.5 μm, and thus the carbon nanowalls are formed random on the substrate 1. If the widths of the protruding portions 11 are as wide as 4.7-4.8 μm and 4.3-4.4 μm like Pattern No. 4 and 11, for example, even though the recessed portions 12 are formed, the surface of the substrate 1 is considered to be equivalent to a flat surface, and thus the carbon nanowalls are randomly grown.

According to the above, the carbon nanowalls that are aligned in the desired pattern (i.e. the concave-convex configuration of the substrate 1) can be formed by using the substrate 1 that has the concave-convex configuration, in which the width of the protruding portion 11 is narrower than the width of the recessed portion 12 and is 0.5 μm or less.

In the situation of the experiment results of Table 1, the height of the protruding portion 11 (which is equal to the depth of the recessed portion 12) is 0.6 μm. However, the carbon nanowalls are considered to be selectively grown on the protruding portions 11 if the height of the protruding portion 11 (which is equal to the depth of the recessed portion 12) is at least 0.3 μm.

If the height of the protruding portion 11 (which is equal to the depth of the recessed portion 12) is at least 0.3 μm, the width of the protruding portion 11 is 1.7 times the height of the protruding portion 11 (which is equal to the depth of the recessed portion 12) or less, and it is considered that a difference occurs between the protruding portions 11 and the recessed portions 12.

Accordingly, when a ratio of the height of the protruding portion 11 (which is equal to the depth of the recessed portion 12) to the width of the protruding portion 11 is represented by an aspect ratio, the aspect ratio may be 0.6 (i.e. 0.3 μm/0.5 μm=0.6) or more when the carbon nanowalls are aligned in the desired pattern.

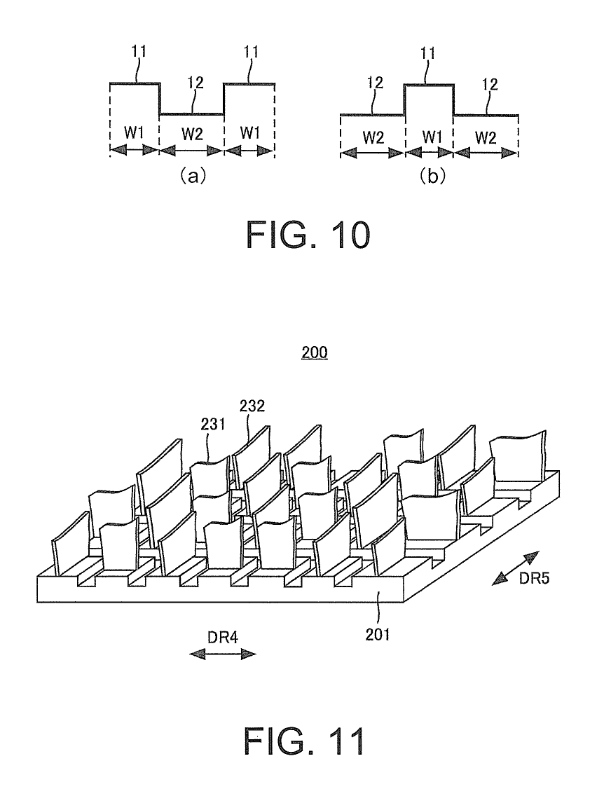

FIG. 10 provides schematic views showing an aperture ratio and a protrusion ratio of the surface of the substrate 1. The aperture ratio of the surface of the substrate 1 is defined as (width of the recessed portion 12)/(width of the protruding portion 11+width of the recessed portion 12+width of the protruding portion 11). Moreover, the protrusion ratio of the surface of the substrate 1 is defined as (width of the protruding portion 11)/(width of the recessed portion 12+width of the protruding portion 11+width of the recessed portion 12).

The width of the protruding portion 11 is defined as W1 and the width of the recessed portion 12 is defined as W2. Accordingly, the aperture ratio is W2/(W1+W2+W1), and the protrusion ratio is W1/(W2+W1+W2).

The aperture ratios and protrusion ratios of Pattern No. 1-11 of Table 1 are respectively calculated and shown in Table 2.

TABLE 2

| | Aperture ratio = width of | Protrusion ratio = width of |
|---|---|---|
| | recessed portion/width of | protruding portion/width of |
| | protruding portion + | recessed portion + |
| Pattern | width of recessed portion + | width of protruding portion + |
| No. | width of protruding portion) | width of recessed portion) |
| 5 | 0.43-0.50 | 0.20-0.25 |
| 6 | 0.82 | 0.05 |
| 7-10 | 0.60-0.65 | 0.12-0.14 |
| 1 | 0.27-0.33 | 0.33-0.40 |
| 2 | 0.25-0.28 | 0.38-0.43 |
| 3 | 0.23-0.25 | 0.43-0.46 |
| 4 | 0.34 | 0.33 |
| 11 | 0.37 | 0.30 |

With respect to Pattern No. 5-10 where the carbon nanowalls are aligned, the aperture ratio is in a range of 0.43-0.82 while the protrusion ratio is in a range of 0.05-0.25.

On the other hand, with respect to Pattern No. 1-4 and 11 where the carbon nanowalls are formed random, the aperture ratio is in a range of 0.23-0.37 while the protrusion ratio is in a range of 0.30-0.46.

Therefore, the carbon nanowalls are aligned when the aperture ratio is 0.43 or more, or when the protrusion ratio is 0.25 or less.

As a result, in the exemplary embodiments of the invention, under the condition that the width of the protruding portion 11 is narrower than the width of the recessed portion 12 and is 0.5 μm or less, the aperture ratio is preferably set to be less than 1 and equal to or more than 0.43, and the protrusion ratio is preferably set to be equal to or less than 0.25.

In the cases of Pattern No. 7-10 as shown in FIG. 7, the alignment of the carbon nanowalls is improved. Therefore, the aperture ratio is more preferably set in a range of 0.60-0.65, and the protrusion ratio is more preferably set in a range of 0.12-0.14.

According to the above descriptions, the substrate 1 has the stripe-like concave-convex configuration; however, the invention is not limited thereto. In other embodiments of the invention, the substrate 1 may have a grid-like concave-convex configuration. Accordingly, in Step S1 of the flowchart of FIG. 5, the substrate 1 having the stripe-like or grid-like concave-convex configuration is disposed in the vacuum container 20.

According to the above descriptions, the inductively coupled plasma is generated by using the plane conductor 50 as the electrode; however, the invention is not limited thereto. In other embodiments of the invention, a conductor of any shape may be used to generate the inductively coupled plasma, and generally the inductively coupled plasma may be generated by supplying the high-frequency current to the electrode (conductor). Accordingly, in Step S4 of the flowchart of FIG. 5, the high-frequency electric power is applied to the electrode.

Further, according to the above descriptions, the carbon nanowall array 10 is manufactured using the inductively coupled plasma; however, the invention is not limited thereto. In other embodiments of the invention, the carbon nanowall array 10 may also be manufactured using a capacitively coupled plasma or an ECR (electron cyclotron resonance) plasma, etc., and generally, the carbon nanowall array 10 may be manufactured by plasma using the aforementioned substrate 1.

Application of the carbon nanowall array is explained below. FIG. 11 is a schematic perspective view of a mold using carbon nanowalls.

With reference to FIG. 11, a mold 200 includes a substrate 201 and carbon nanowalls 231 and 232. The substrate 201 has a grid-like concave-convex configuration on a surface thereof. The concave-convex configuration on the substrate 201 is the same as the concave-convex configuration on the aforementioned substrate 1. The carbon nanowall 231 is formed on the substrate 201 along a direction DR4, and the carbon nanowall 232 is formed on the substrate 201 along a direction DR5.

A plurality of the carbon nanowalls 231 and a plurality of the carbon nanowalls 232 are respectively formed on the surface of the substrate 201. Accordingly, an array of the carbon nanowalls 231 and carbon nanowalls 232 is formed in a predetermined pattern. The mold 200 is used to form a resin in the predetermined pattern.

In addition to the above, the carbon nanowalls are used in TFT (thin film transistor), heat radiating element, or vacuum switch, etc. When used in TFT, the carbon nanowalls are used in a channel layer of the TFT.

It should be understood that the exemplary embodiments described above do not disclose all aspects of the invention and thus are not restrictive to the invention. Therefore, the scope of the invention is not limited to the descriptions of the above exemplary embodiments but defined in the claims below, and is intended to cover all equivalents of the claims and all modifications/alterations that fall within the claim scope.

### INDUSTRIAL APPLICABILITY

The invention is applicable to a carbon nanowall array and a method of manufacturing carbon nanowalls.

What is claimed is:

1. A carbon nanowall array, comprising:
a substrate having a main surface formed with a stripe-like or grid-like concave-convex configuration; and
a plurality of nanowalls each formed on a protruding portion of the concave-convex shape along a length direction of the protruding portion,
wherein a width of the protruding portion in an in-plane direction of the substrate is narrower than a width of a recessed portion of the concave-convex shape in the in-plane direction of the substrate, and the width of the protruding portion is 0.5 μm or less.

2. A method for manufacturing a carbon nanowall by using plasma, comprising:
a first process of disposing a substrate, which has a main surface formed with a stripe-like or grid-like concave-convex configuration, in a vacuum container;
a second process of heating a temperature of the substrate to a desired temperature;
a third process of introducing a material gas containing carbon atoms into the vacuum container; and
a fourth process of applying a high-frequency electric power to an electrode,
wherein a width of a protruding portion of the concave-convex shape in an in-plane direction of the substrate is narrower than a width of a recessed portion of the concave-convex shape in the in-plane direction of the substrate, and the width of the protruding portion is 0.5 μm or less.
